(19) United States
(12) Patent Application Publication
(10) Pub. No.: US 2005/0024687 A1
(43) Pub. Date: Feb. 3, 2005

(54) Communication apparatus

(76) Inventor: Hiroaki Hanafusa, Nara-shi (JP)

Correspondence Address: BIRCH STEWART KOLASCH & BIRCH, PO BOX 747, FALLS CHURCH, VA, 22040-0747, US

(21) Appl. No.: 10/902,038

(22) Filed: Jul. 30, 2004

(30) Foreign Application Priority Data
Jul. 31, 2003 (JP) P2003-284532

(51) Int. Cl. H04N 1/00; H04N 1/04

(52) U.S. Cl. 358/400; 358/474

(57) ABSTRACT

A communication apparatus capable of selectively outputting only transmission result information on desired transmission in a simple operation, is provided. The communication apparatus has a transmitting and receiving portion for transmitting to a destination via a communication line by facsimile communication, Internet communication or the like, and a first condition with respect to whether or not to store or whether or not to output transmission result information showing a transmission result of transmission information transmitted from the transmitting and receiving portion is set before predetermined transmission information is transmitted. A main unit control portion gives a priority to the second condition than to the preset first condition when outputting the transmission result information is inputted by the report key as the second condition, and causes a printing portion to output the transmission result information by printing.

### CROSS REFERENCE TO RELATED APPLICATION

This nonprovisional application claims priority under 35 U.S.C. § 119(a) on Japanese patent application No. 2003-284532 filed on Jul. 31, 2003, the entire contents of which are hereby incorporated by reference.

### BACKGROUND OF THE INVENTION

1. Field of the Invention

The present invention relates to a communication apparatus which, when transmission information is transmitted via a communication line by fax or electronic mail, outputs transmission result information showing a result of the transmission, and which can be properly embodied as a facsimile apparatus or the like.

2. Description of the Related Art

In recent years, a communication apparatus capable of, when transmission information is transmitted, outputting transmission result information showing the result of the transmission is put to practical use. A facsimile apparatus typical of such a communication apparatus is capable of, when finishing facsimile transmission, printing and outputting the transmission result information such as the date, a telephone number of a destination, the number of documents and the like in the transmission, to a sheet of paper. There is a case where transmission information to be transmitted is transmitted immediately after a document is read, and there is a case where read information on a read document is stored into a memory once and the transmission information stored in the memory is read out and transmitted later, which is accumulation transmission. In a case where plural people execute the latter accumulation transmission, plural pieces of transmission information are transmitted and thereafter the transmission result information is outputted for each of the transmission information, and it becomes impossible to make each of the transmission result information correspond to each of the transmitters and easily identify, so that personal identification information such as a name and an ID code for identifying the transmitter is outputted in each of the transmission result information so that the correspondence between each of the transmitters and each of the transmission result information can be confirmed.

As to the transmission result information, when a document is set on a document inserting portion of the facsimile apparatus, the date, the time and the like are displayed on a display portion, and subsequently, when a facsimile number of a destination is inputted from a key inputting portion, the facsimile number is displayed on the display portion and stored into the memory. Further subsequently, when a name or an ID code, which is the personal identification information, is inputted from the key inputting portion, the inputted name or ID code and a facsimile telephone number of a destination corresponding thereto are displayed on the display portion. When a start key of the key inputting portion is operated in this state, reading of the set document is started, and read data of the document is accumulated into the memory as transmission information. The transmission information accumulated in the memory is transmitted to the destination by fax when reading of the document is finished, and the transmission result information is outputted when the transmission is finished. Therefore, in such a facsimile apparatus, every time transmission is finished, the transmission result information is outputted by printing or displaying, automatically in a sense (refer to Japanese Unexamined Patent Publication JP-A 6-30231 (1994), for example).

Further, in another related art, a communication apparatus similar to that of the aforementioned related art is structured in a manner that one of ‘output at all times,’ ‘output at no time’ and ‘output only when there is an error’ can be selected and set, as to output of the transmission result information.

In the former related art, even when there is no need to output the transmission result information, the transmission result information is outputted every time transmission is finished though output of the transmission result information is not necessary, because a structure for easily selecting and setting whether or not to output the transmission result information is not provided. Therefore, there is a problem such that a complicated operation is required for each transmission in order to switch between output and non-output of the transmission result information depending on whether the transmission result information is necessary or unnecessary.

Further, in the latter related art, as to the settings of output and non-output of the transmission result information, it is impossible to minutely set for each transmission though it is possible to roughly select as-mentioned before. That is to say, it is impossible to minutely set by making the transmission time, the kind of communication, a destination and the like to be an output condition or a non-output condition. Thus, in a case where there is even one transmission information that the transmitter desires output of the transmission result information among plural pieces of transmission information, it is required to select and set ‘output at all times.’ In a case where ‘output at all times’ is selected and set in this manner, there is a problem such that since not only the transmission result information that the transmitter desires output but also the transmission result information that the transmitter does not desire output are outputted, paper sheets for recording the transmission result information are wasted and an arrangement of the transmission result information is complicated.

### SUMMARY OF THE INVENTION

An object of the invention is to provide a communication apparatus capable of selectively outputting only transmission result information on desired transmission in a simple operation.

The invention provides a communication apparatus comprising a transmitting portion for transmitting predetermined transmission information to a destination via a communication line, the communication apparatus being capable of, before transmitting the predetermined transmission information, setting a first condition with respect to whether or not to store or output transmission result information showing a transmission result of transmission information transmitted from the transmitting portion, the communication apparatus further comprising:
inputting means for inputting a second condition with respect to whether or not to store or output the transmission result information for each transmission;
storing means for storing the transmission result information;
outputting means for outputting the transmission result information; and
controlling means for giving a priority to the second condition than to the preset first condition when storing the transmission result information is inputted as the second condition, and causing the storing means to store the transmission result information, and for giving a priority to the second condition than to the preset first condition when outputting the transmission result information is inputted as the second condition, and causing the outputting means to output the transmission result information.

The invention provides a communication apparatus comprising a transmitting portion for transmitting predetermined transmission information to a destination via a communication line, wherein a first condition with respect to whether or not to store or output transmission result information showing a transmission result of transmission information transmitted from the transmitting portion is set as initial setting, the communication apparatus further comprising:
inputting means for inputting a second condition with respect to whether or not to store or output the transmission result information for each transmission;
storing means;
outputting means; and
controlling means for controlling, when the second condition is inputted from the inputting means, the storing means with respect to storage of the transmission result information or the outputting means with respect to output of the transmission result information according to the second condition instead of the first condition.

Further, in the invention it is preferable that:
a third condition with respect to whether or not to transmit the transmission result information from the transmitting portion is inputted from the inputting means; and
the controlling means causes the transmitting portion to transmit the transmission result information when it is inputted as the third condition inputted from the inputting means to transmit the transmission result information.

Still further, in the invention it is preferable that:
the outputting means includes displaying means which is caused to display predetermined information by the controlling means; and
when storing or outputting the transmission result information is inputted from the inputting means, the controlling means causes the displaying means to display result display confirming information showing that the transmission result information is stored or outputted, and thereafter, when a predetermined setting operation for transmission is finished, the controlling means deletes the display of the result display confirming information on the display means.

The invention provides a communication apparatus comprising a transmitting portion for transmitting predetermined transmission information to a destination via a communication line, wherein a first condition with respect to whether or not to store or output transmission result information showing a transmission result of transmission information transmitted from the transmitting portion is set as initial setting, the communication apparatus further comprising:
a controlling device;
an inputting device connected to the contolling device, for inputting a second condition with respect to whether or not to store or output the transmission result information for each transmission;
a storing device connected to the controlling device; and
an outputting device connected to the controlling device,
wherein the controlling device controls, when the second condition is inputted from the inputting device, the storing device with respect to storage of the transmission result information or the outputting device with respect to output of the transmission result information according to the second condition instead of the first condition.

In the invention it is preferable that:
a third condition with respect to whether or not to transmit the transmission result information from the transmitting portion is inputted from the inputting device; and
the controlling device causes the transmitting portion to transmit the transmission result information when transmitting the transmission result information is inputted as the third condition inputted from the inputting device.

Further, in the invention it is preferable that:
the outputting device includes a displaying device which is connected to the controlling device and caused to display predetermined information by the controlling device; and
when storing or outputting the transmission result information is inputted from the inputting device, the controlling device causes the displaying device to display result display confirming information showing that the transmission result information is stored or outputted, and thereafter, when a predetermined setting operation for transmission is finished, the controlling device deletes the display of the result display confirming information on the display device.

According to the invention, the communication apparatus has the transmitting portion for transmitting to a destination via the communication line by facsimile communication, Internet communication or the like, and the first condition whether or not to store or whether or not to output the transmission result information showing a transmission result of transmission information transmitted from the transmitting portion is set before the predetermined transmission information is transmitted. The controlling means gives a priority to the second condition than to the preset condition when stroting the transmission result information is inputted as the second condition from the inputting means, and causes the storing means to store the transmission result information. Moreover, the controlling means gives a priority to the second condition than to the preset first condition when outputting the transmission result information is inputted as the second condition from the inputting means, and causes the outputting means to output the transmission result information by displaying or printing.

Since whether or not to store or whether or not to output the transmission result information on the transmission information after transmission information is transmitted, is set by giving a priority over a setting state before transmission in this manner, what is required is merely to set from the inputting means only in the case of a different setting from an initial setting before transmission. Therefore, the need for setting whether or not to store or whether or not to output the transmission result information for all transmission information is eliminated, with the result that it is possible to selectively output only the transmission result information on desired transmission in a simple operation.

Further, according to the invention, it is possible to select and input the third condition with respect to whether or not to transmit the transmission result information from the transmitting portion by the use of the inputting means. When it is inputted as the third condition from the inputting means to transmit the transmission result information, the controlling means can cause the transmitting portion to transmit the transmission result information, and inform by transmitting the transmission result information to a destination of transmission information and a destination different from the destination of the transmission information. This enables confirmation of the transmission result information by not only a personal communication apparatus but also another communication apparatus existing in a separate place, and the convenience of the confirmation of the transmission result information is increased.

Still further, according to the invention, the controlling means causes the displaying means to display the result display confirming information showing to store or output the transmission result information when storing or outputting the transmission result information is inputted from the inputting means, and thereafter, when the predetermined setting operation for transmission is finished, the controlling means deletes the display of the result display confirming information on the displaying means. Since the result display confirming information is displayed on the displaying means in this manner, it is possible, when current transmission is finished, to make a transmitter recognize that the transmission result information thereof is stored or outputted. Moreover, since the result display confirming information displayed by the displaying means is deleted when the predetermined setting operation for transmission is finished, it is possible by thus deleting the display of the result display confirming information to make the transmitter recognize that whether to store or whether to output the transmission result information on subsequent transmission is not set.

### BRIEF DESCRIPTION OF THE DRAWINGS

Other and further objects, features, and advantages of the invention will be more explicit from the following detailed description taken with reference to the drawings wherein:

FIG. 1 is a block diagram showing an electrical structure of a communication apparatus, which is an embodiment of the invention;

FIG. 2 is a perspective view of the communication apparatus;

FIG. 3 is a front view of a panel portion;

FIG. 4 is a flowchart for describing an example of an operation process for outputting transmission result information;

FIGS. 5A to 5I are views showing screens displayed on a display portion at the time of an operation according to the example of the operation process described by the use of FIG. 4;

FIGS. 6A and 6B are views showing communication result reports;

FIG. 7 is a flowchart for describing another example of the operation process for outputting the transmission result information; and

FIGS. 8A to 8G are views showing screens displayed on the display portion at the time of an operation according to the other example of the operation process described by the use of FIG. 7.

### DETAILED DESCRIPTION

Now referring to the drawings, preferred embodiments of the invention are described below.

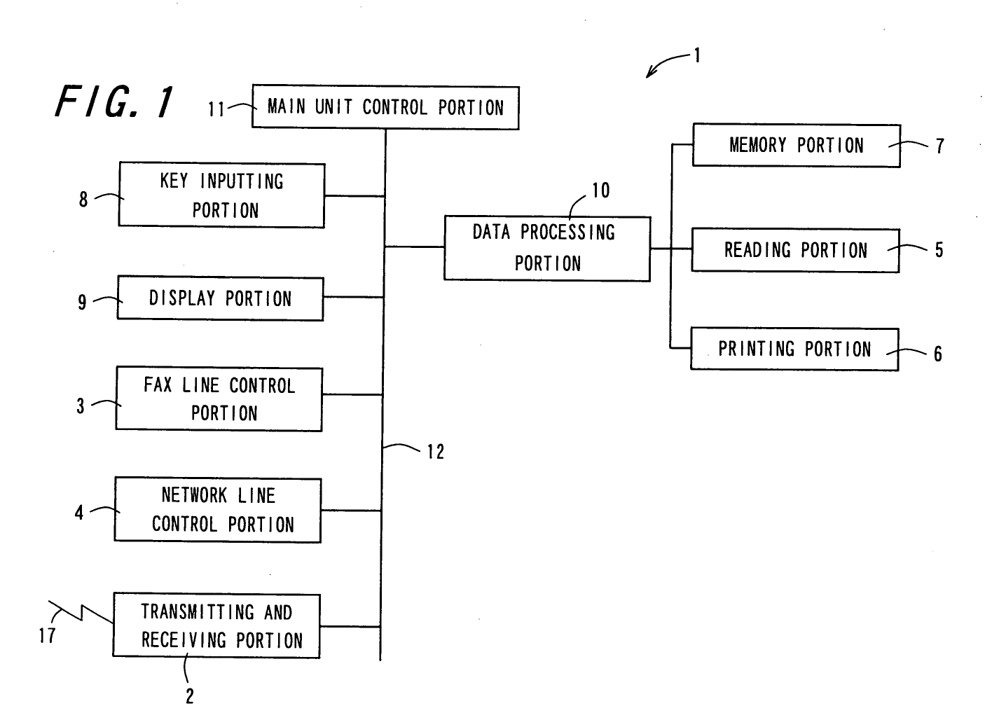

FIG. 1 is a block diagram showing an electrical structure of a communication apparatus 1, which is an embodiment of the invention. The communication apparatus 1 of the present embodiment is realized as a facsimile apparatus which has a facsimile communication function and a network communication function. The network communication function is, for example, e-mail communication. The communication apparatus 1 comprises a transmitting and receiving portion 2, a facsimile (FAX) line control portion 3, a network line control portion 4, a reading portion 5, a printing portion 6, a memory portion 7, a key inputting portion 8, a display portion 9, a data processing portion 10 and a main unit control portion 11. The respective portions are connected via a bus line 12.

The communication apparatus 1 of the present embodiment is capable of setting a first condition with respect to whether or not to store or whether or not to output transmission result information showing a transmission result of predetermined transmission information transmitted from the transmitting and receiving portion 2, for example, as an initial setting, before transmitting the predetermined transmission information. The predetermined transmission information is image information generated by the reading portion 5. The predetermined transmission information is not necessarily limited to the image information generated by the reading portion 5, and may be information previously stored in the memory portion 7, for example.

The transmitting and receiving portion 2 transmits the predetermined transmission information to a destination via a communication line 17, and receives predetermined reception information via the communication line 17. Describing in detail, the transmitting and receiving portion 2 executes transmission and reception of data by facsimile communication and transmission and reception of data by network communication such as electronic mail communication, gives the predetermined reception information received via the communication line 17 to the data processing portion 10, and transmits the predetermined transmission information from the data processing portion 10 to the destination via the communication line 17. The transmitting and receiving portion 2 is a transmitting portion. The transmitting and receiving portion 2 includes a network interface card (abbreviated as NIC).

The FAX line control portion 3 executes control for facsimile communication. Describing in detail, when a transmitter executes an operation for transmission by facsimile communication, the FAX line control portion 3 executes the control for facsimile communication by using the image information as the predetermined transmission information, destination information and the like. In concrete, the control for facsimile communication includes a dialing-communication protocol control. When the predetermined transmission information is transmitted by facsimile communication, the FAX line control portion 3 generates the transmission result information showing the result of the transmission.

The network line control portion 4 executes control for electronic mail communication. Describing in detail, when the transmitter executes an operation for transmission by network communication, the network line control portion 4 executes the control for network communication via the NIC by using the image information as the predetermined transmission information, the destination information and the like. When the predetermined transmission information is transmitted by electronic mail communication, the network line control portion 4 generates the transmission result information showing the result of the transmission.

The reading portion 5 reads an image formed on a document 18, and generates the image information. The printing portion 6 forms the image on a recording sheet. The printing portion 6 is outputting means, and outputs the transmission result information. The printing portion 6 prints a transmission result report, which is the transmission result information, on a recording sheet.

The memory portion 7 temporarily stores the predetermined transmission information and the predetermined reception information. Moreover, the memory portion 7 stores the destination information inputted from the key inputting portion 8 described later. The destination information includes a facsimile number and a mail address. Furthermore, the memory portion 7 stores a second condition inputted from inputting means 20 described later. Besides, the memory portion 7 is storing means, and stores the transmission result information. The memory portion 7 is realized by a random access memory (abbreviated as RAM) or the like.

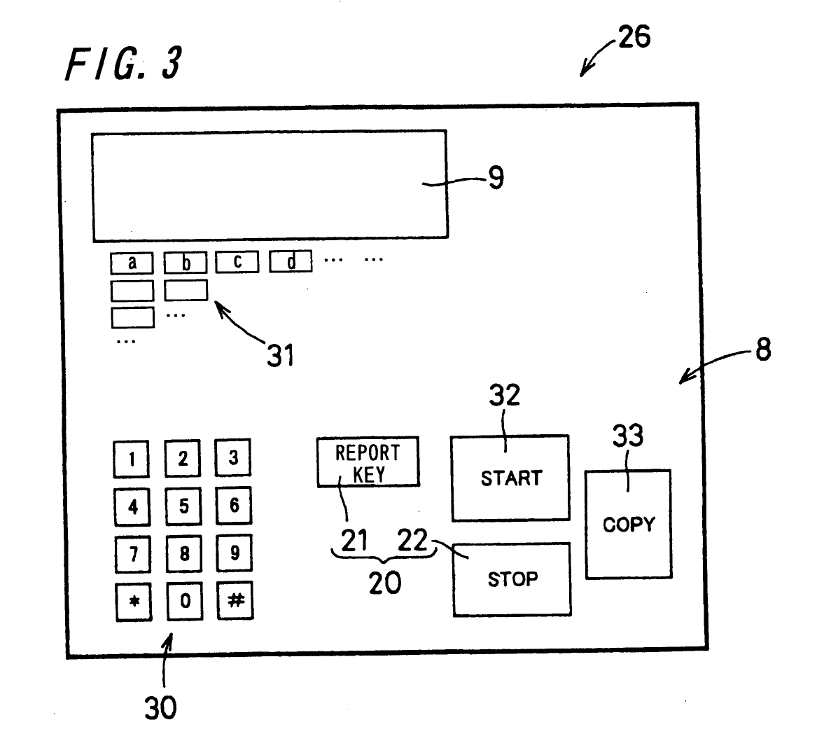

The key inputting portion 8 has the inputting means 20. The inputting means 20 inputs the second condition with respect to whether or not to store or whether or not to output the transmission result information for each transmission. The inputting means 20 includes a report key 21 and a stop key 22 (refer to FIG. 3 described later). The display portion 9 is displaying means, and displays predetermined information.

The data processing portion 10 encodes and decodes the image information. In concrete, the data processing portion 10 encodes the image information generated by the reading portion 5 and gives to the memory portion 7. Moreover, the data processing portion 10 decodes the image information of the predetermined reception information stored in the memory portion 7 and gives to the printing portion 6.

The main unit control portion 11 controls the respective portions of the communication apparatus 1. The main unit control portion 11 is controlling means. The main unit control portion 11 gives a priority to the second condition than to the preset first condition when storing the transmission result information is inputted as the second condition from the inputting means 20, and causes the memory portion 7 to store the transmission result information, and gives a priority to the second condition than to the preset first condition when outputting the transmission result information is inputted as the second condition from the inputting means 20, and causes the printing portion 6 to output the transmission result information. That is, the main unit control portion 11 controls, when the second condition is inputted from the inputting means 20, the memory portion 7 with respect to storage of the transmission result information or the printing portion 6 with respect to output of the transmission result information according to the second condition instead of the first condition.

Further, when storing or outputting the transmission result information is inputted by the report key 21, the main unit control portion 11 causes the display portion 9 to display result display confirming information showing to store or output the transmission result information, and thereafter, when a predetermined setting operation for transmission is finished, the main unit control portion 11 deletes the display of the result display confirming information on the display portion 9.

The main unit control portion 11 includes a central processing unit (abbreviated as CPU) and a program storing portion. In the program storing portion, programs and data for controlling the respective portions of the communication apparatus 1 are stored. The program storing portion is realized by a read only memory (abbreviated as ROM) or the like. In the present embodiment, the program refers to a software program which can be executed by a computer.

Among the respective portions, the transmitting and receiving portion 2, the FAX line control portion 3, the network line control portion 4, the reading portion 5, the printing portion 6, the memory portion 7, the data processing portion 10 and the main unit control portion 11 are included in a communication apparatus main unit 16 described later.

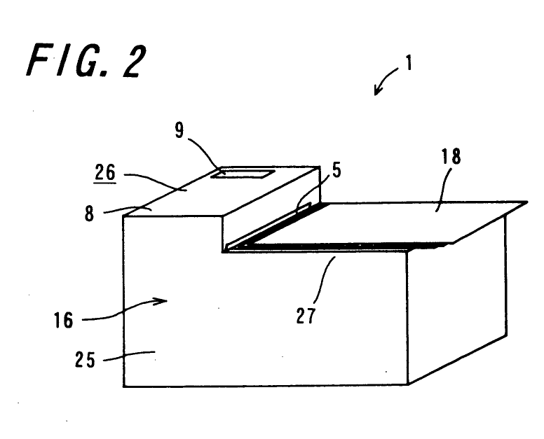

FIG. 2 is a perspective view of the communication apparatus 1. The communication apparatus 1 is placed on a horizontal plane in an actual use state thereof. The communication apparatus 1 comprises the communication apparatus main unit 16. The communication apparatus main unit 16 has a base portion 25, the panel portion 26 and a document placing portion 27. The panel portion 26 and the document placing portion 27 are connected to the upper portion of the base portion 25. The panel portion 26 protrudes more upward than the document placing portion 27. The base portion 25 contains recording sheets. The recording sheets contained in the base portion 25 are supplied to the printing portion 6 one by one. On the document placing portion 27, the documents 18 are placed. The documents 18 placed on the document placing portion 27 are supplied to the reading portion 5 one by one.

The document placing portion 27 is provided with a document detecting portion which is not shown in the drawings. The document detecting portion is capable of detecting the presence of the document 18. The document detecting portion gives a document detecting signal showing that the document 18 is set to the main unit control portion 11 when the document 18 is set. In the present embodiment, to set the document 18 is to place the document 18 in a predetermined position on the document placing portion 27.

FIG. 3 is a front view of the panel portion 26. The panel portion 26 is provided with the key inputting portion 8 and the display portion 9. The key inputting portion 8 includes, in addition to the report key 21 and the stop key 22, a facsimile number inputting key 30 for inputting a facsimile number, a mail address inputting key 31 for inputting a mail address, a start key 32 inputting a reading start command, and a copy key 33 inputting a copying start command. Moreover, the key inputting portion 8 further includes keys for various kinds of settings such as an image quality setting and a density setting, which are not shown in the drawings.

The facsimile number inputting key 30 has keys necessary for inputting a facsimile number. In concrete, the facsimile number inputting key 30 has keys for inputting numerals, and the like. The mail address inputting key 31 has keys necessary for inputting a mail address. In concrete, the mail address inputting key 31 has keys for inputting alphabets, and the like.

When the start key 32 is pressed down and the reading start command is inputted in a state where the document 18 is set, reading of the document 18 by the reading portion 15 is started. Moreover, when the copy key 33 is pressed down and the copying start command is inputted in a state where the document 18 is set, copy by the reading portion 15 and the printing portion 6 is started.

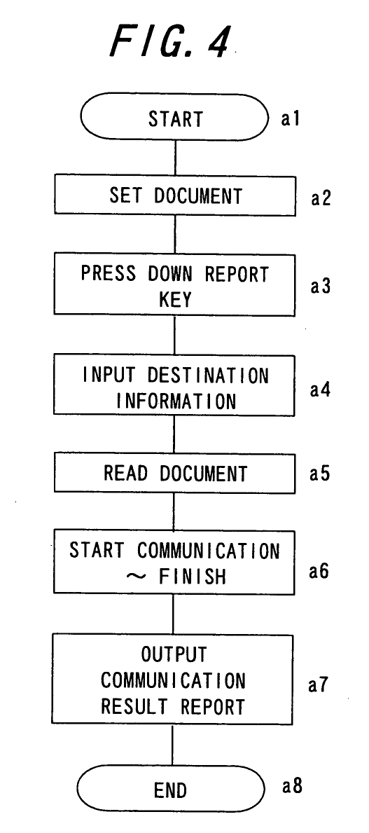

In the following, referring to FIGS. 4, 5A to 5I, 6A and 6B, 7 and 8, operation processes relating to output of the transmission result information will be described. Moreover, the description will be given on the assumption that it is set as the preset first condition of not outputting the transmission result information. Furthermore, in the present embodiment, an operation process in facsimile communication and an operation process in electronic mail communication are similar, so that the operation process in facsimile communication and the operation process in electronic mail communication will be described together.

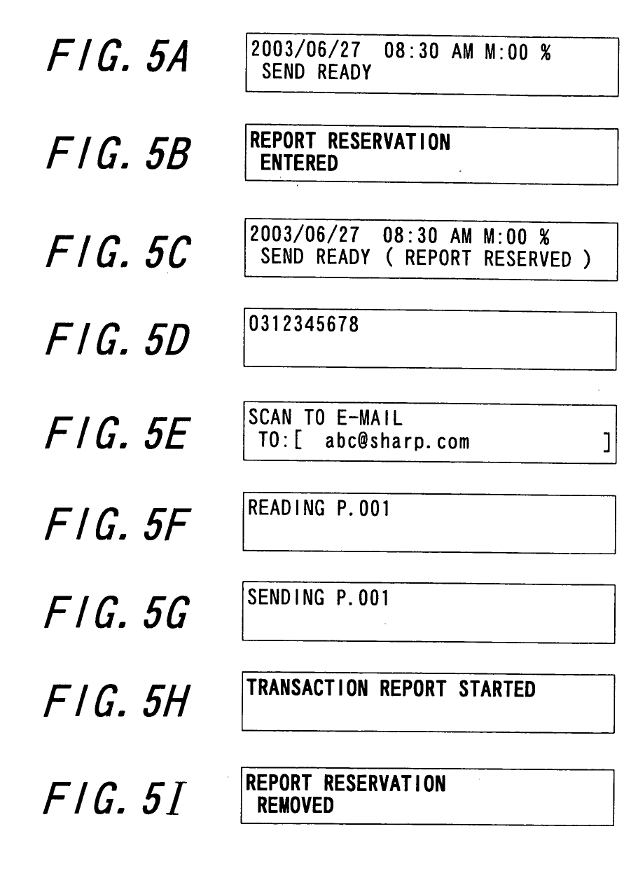

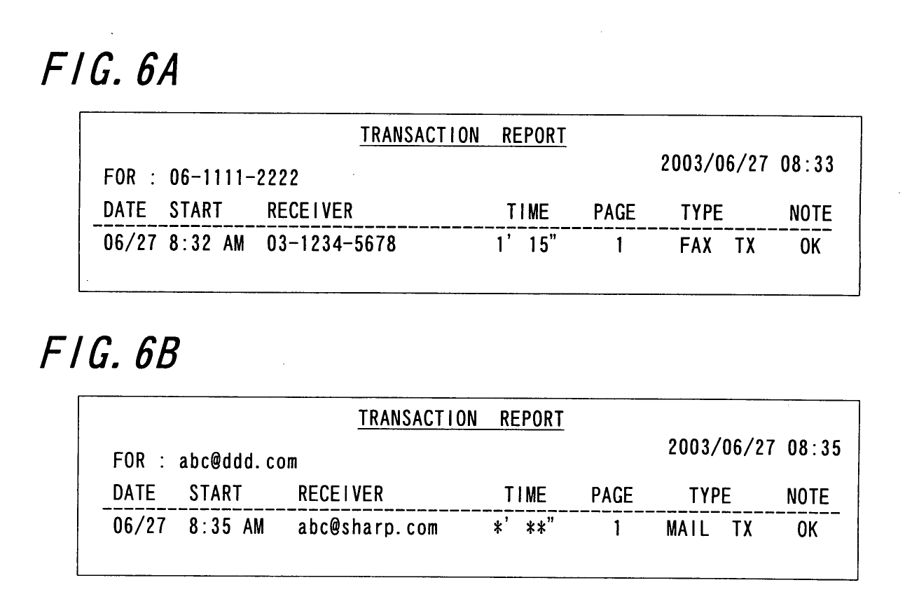

FIG. 4 is a flowchart for describing an example of an operation process for outputting the transmission result information. FIGS. 5A to 5I are views showing screens displayed on the display portion 9 at the time of an operation according to the example of the operation process described using FIG. 4, FIG. 5A shows a screen when the document 18 is set, FIG. 5B shows a screen when the report key 21 is pressed down, FIG. 5C shows a standby screen after the report key 21 is pressed down, FIG. 5D shows a screen when a facsimile number is inputted, FIG. 5E shows a screen when a mail address is inputted, FIG. 5F shows a screen when reading of the document 18 is started, FIG. 5G shows a screen when transmission of the image information is started, FIG. 5H shows a screen when output of the transmission result information is started, and FIG. 5I shows a screen when the stop key 22 is pressed down. FIGS. 6A and 6B are views showing communication result reports, FIG. 6A shows an example of a communication result report in the case of facsimile communication and FIG. 6B shows an example of a communication result report in the case of electronic mail communication. Referring to FIGS. 4, 5A to 5I, and 6B, a case where transmission information to be transmitted is transmitted immediately after the document 18 is read will be described.

At step a1, the transmitter prepares the document 18 and starts an operation of the communication apparatus 1. Subsequently, at step a2, the transmitter sets the document 18. When the document 18 is set, the document detecting signal showing that the document 18 is set is given from the document detecting portion to the main unit control portion 11, and the main unit control portion 11 causes the display portion 9 to display the screen shown in FIG. 5A.

At this moment, ‘SEND READY’ is displayed on the display portion 9. This can inform the transmitter that the document 18 is set. Moreover, the present date, the present time, a use condition of the memory portion 7 and the like are displayed on the display portion 9. A display of the present date is ‘2003/06/27,’ for example. A display of the present time is ‘08:30 AM,’ for example. A display of the use condition of the memory portion 7 is ‘M: 00%,’ for example.

Next, at step a3, the transmitter presses down the report key 21. When the report key 21 is pressed down, it is inputted as a second condition from the inputting means 20 to output the transmission result information, and the main unit control portion 11 causes the display portion 9 to display the screen shown in FIG. 5B. At this moment, ‘REPORT RESERVATION’ and ‘ENTERED’ are displayed on the display portion 9. This can inform the transmitter that the report key 21 is pressed down.

After that, the main unit control portion 11 causes the display portion 9 to display the standby screen shown in FIG. 5C. At this moment, ‘SEND READY (REPORT RESERVED)’ of the result display confirming information is displayed on the display portion 9. This can inform the transmitter that the report key 21 has already been pressed down. Moreover, the present date, the present time, the use condition of the memory portion 7 and the like are displayed on the display portion 9 in the same manner as the screen shown in FIG. 5A.

The standby screen shown in FIG. 5C is displayed under a standby state for waiting for various operations from the transmitter, between a point that the report key 21 is pressed down and a point that the start key 32 is pressed down at step a5 described later. Thus, in the standby state between the point that the report key 21 is pressed down and the point that the start key 32 is pressed down, the result display confirming information such as the standby screen shown in FIG. 5C is displayed. As a result, in between the respective operations, it is possible to make the transmitter recognize that the report key 21 has already been pressed down.

Next, at step a4, the transmitter executes an operation for inputting the destination information. In concrete, the transmitter executes an operation for inputting a facsimile number as the destination information in the case of desiring facsimile communication, and the transmitter executes an operation for inputting a mail address as the destination information in the case of desiring electronic mail communication.

In the case of facsimile communication, the transmitter firstly executes, on the key inputting portion 8, a predetermined operation for causing the display portion 9 to display a facsimile number inputting screen. When the predetermined operation is executed on the key inputting portion 8, the main unit control portion 11 causes the display portion 9 to display the facsimile number inputting screen.

When the facsimile number inputting screen is displayed on the display portion 9, the transmitter presses down the facsimile number inputting key 30. When the facsimile number inputting key 30 is pressed down, a facsimile number is inputted by the facsimile number inputting key 30 having been pressed down, and the main unit control portion 11 causes the display portion 9 to display the screen shown in FIG. 5D. At this moment, the inputted facsimile number is displayed on the display portion 9. This can inform the transmitter of the inputted facsimile number. A display of the facsimile number is ‘0312345678,’ for example.

In the case of electronic mail communication, the transmitter firstly executes, on the key inputting portion 8, a predetermined operation for causing the display portion 9 to display a mail address inputting screen. When the predetermined operation is executed on the key inputting portion 8, the main unit control portion 11 causes the display portion 9 to display the mail address inputting screen.

When the mail address inputting screen is displayed on the display portion 9, the transmitter presses down the mail address inputting key 31. When the mail address inputting key 31 is pressed down, a mail address is inputted by the mail address inputting key 31 having been pressed down, and the main unit control portion 11 causes the display portion 9 to display the screen shown in FIG. 5E.

At this moment, the inputted mail address is displayed on the display portion 9. This can inform the transmitter of the inputted mail address. On the display portion 9, ‘SCAN TO E-MAIL’ and ‘TO: [abc@sharp.com]’ are displayed, for example. Here, ‘abc@sharp.com’ corresponds to the inputted mail address.

At step a4, the transmitter can execute the various kinds of settings such as the image quality setting and the density setting, by operating keys for executing the various kinds of settings such as the image quality setting and the density setting.

Next, at step a5, the transmitter presses down the start key 32. When the start key 32 is pressed down, the main unit control portion 11 causes the reading portion 5 to start reading of the document 18. Moreover, when the start key 32 is pressed down, the main unit control portion 11 causes the display portion 9 to display the screen shown in FIG. 5F. At this moment, ‘READING P. 001’ is displayed on the display portion 9, for example. This can inform the transmitter that the document is being read.

When reading of the document 18 is finished, the main unit control portion 11 causes the data processing portion 10 to encode the image information generated by the reading portion 5, and stores into the memory portion 7. At this moment, the main unit control portion 11 associates the condition inputted at step a3 and the destination information inputted at step a4 with the image information, and stores into the memory portion 7.

In this manner, when outputting the transmission result information is inputted from the inputting means 20, that is, when the report key 21 is pressed down, the main unit control portion 11 causes the display portion 9 to display the result display confirming information showing that the transmission result information is outputted. Thereafter, when a predetermined setting operation for transmission is finished, the main unit control portion 11 deletes the display of the result display confirming information on the display portion 9. The predetermined setting operation is a setting operation from setting the document 18 to pressing down the start key 32, and includes an operation for inputting the destination information and an operation for the various kinds of settings such as the image quality setting and the density setting.

Next, at step a6, the image information stored in the memory 7 is transmitted by the transmitting and receiving portion 2 to a destination associated with the destination information inputted at step a4 via the communication line 17. In the case of facsimile communication, the image information stored in the memory portion 7 is given to the transmitting and receiving portion 2 via the FAX line control portion 3, and transmitted from the transmitting and receiving portion 2 via the communication line 17. In the case of electronic mail communication, the image information stored in the memory portion 7 is given to the transmitting and receiving portion 2 via the network line control portion 4, and transmitted from the transmitting and receiving portion 2 via the communication line 17.

Further, the main unit control portion 11 causes the display portion 9 to display the screen shown in FIG. 5G. At this moment, ‘SENDING P. 001’ is displayed on the display portion 9, for example. This can inform the transmitter that the image information is being transmitted.

When transmission of the image information stored in the memory portion 7 is finished, the transmission result information is generated subsequently at step a7.

In the case of facsimile communication, the FAX line control portion 3 refers to the condition from the inputting means 20 associated with the transmitted image information and stored in the memory 7, and generates the transmission result information as well as other information. When generation of the transmission result information is completed, the main unit control portion 11 causes the printing portion 6 to print the transmission result information. The communication result report shown in FIG. 6A is printed out by the printing portion 6 to a recording sheet as the transmission result information.

On the communication result report, for example, a facsimile number of the transmitter ‘06-1111-2222,’ the date and time when the transmission result information is generated ‘2003/06/27 08:33,’ the date when transmission is started ‘06/27,’ the time when the transmission is started ‘8:32 AM,’ the facsimile number of the destination ‘03-1234-5678,’ the time occupied by the transmission ‘1’15″,’ the number of the documents 18 ‘1,’ the kind of communication ‘FAX TX’ and the presence of an error ‘OK’ are displayed.

In the case of electronic mail communication, the network line control portion 4 refers to the condition from the inputting means 20 associated with the transmitted image information and stored in the memory 7, and generates the transmission result information as well as other information. When generation of the transmission result information is completed, the main unit control portion 11 causes the printing portion 6 to print the transmission result information. The communication result report shown in FIG. 6B is printed out by the printing portion 6 to a recording sheet as the transmission result information.

On the communication result report, for example, a mail address of the transmitter ‘abc@ddd.com,’ the date and time when the transmission result information is generated ‘2003/06/27 08:35,’ the date when transmission is started ‘06/27,’ the time when the transmission is started ‘8:35 AM,’ the mail address of the destination ‘abc@sharp.com,’ the number of the documents 18 ‘1,’ the kind of communication ‘MAIL TX’ and the presence of an error ‘OK’ are displayed.

Further, the main unit control portion 11 causes the display portion 9 to display the screen shown in FIG. 5H. At this moment, ‘TRANSACTION REPORT STARTED’ is displayed on the display portion 9. This informs the transmitter that output of the transmission result information is started. After that, at step a8, the transmitter ends the operation of the communication apparatus 1.

The order of step a3 and step a4 may be reversed. That is to say, the report key 21 may be pressed down after the destination information is inputted. In other words, the report key 21 may be pressed down between a point that the document 18 is set at step a2 and a point that the start key 32 is pressed down at step a5.

In the present embodiment, even if the report key 21 is pressed down, and it is thereby inputted once as the condition from the inputting means 20 to output the transmission result information, the transmission result information is not outputted when the stop key 22 is pressed down before the start key 32 is pressed down.

When the report key 21 is once pressed down and thereafter the stop key 22 is pressed down, the main unit control portion 11 causes the display portion 9 to display the screen shown in FIG. 5I. At this moment, ‘REPORT RESERVATION’ and ‘REMOVED’ are displayed on the display portion 9. This can inform the transmitter that the stop key 22 is pressed down.

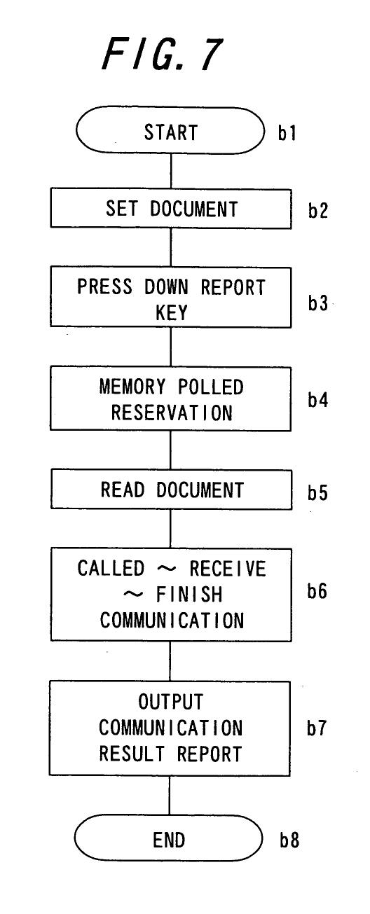

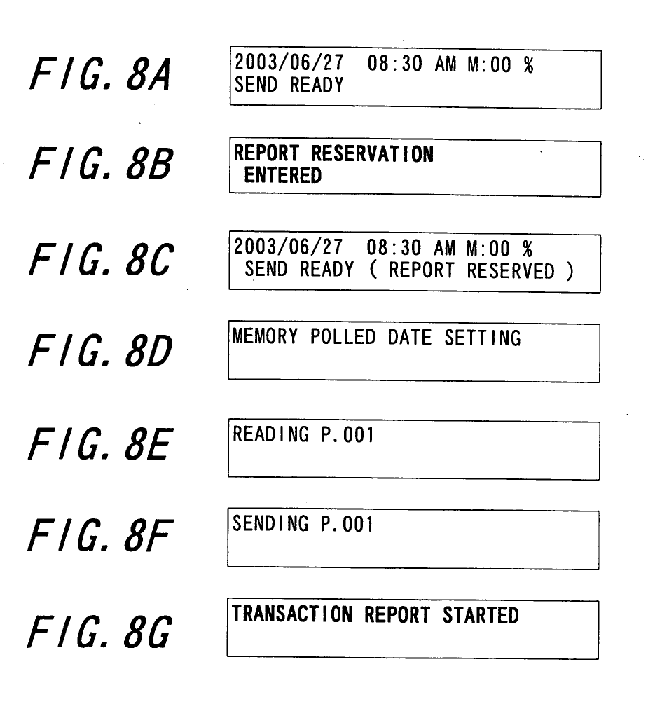

FIG. 7 is a flowchart for describing another example of the operation process for outputting the transmission result information. FIGS. 8A to 8G are views showing screens displayed on the display portion 9 at the time of an operation according to the other example of the operation process described using FIG. 7, FIG. 8A shows a screen when the document 18 is set, FIG. 8B shows a screen when the report key 21 is pressed down, FIG. 8C shows a standby screen after the report key 21 is pressed down, FIG. 8D shows a screen when polled reservation is made, FIG. 8E shows a screen when reading of the document 18 is started, FIG. 8F shows a screen when transmission of the image information is started, and FIG. 8G shows a screen when output of the transmission result information is started. Referring to FIGS. 7 and 8A to 8G, a case where the image information generated by the reading portion 5 and stored in the memory portion 7 is transmitted as predetermined transmission information when there is a transmission request (polling) will be described.

At step b1, the transmitter prepares the document 18 and starts the operation of the communication apparatus 1. Subsequently, at step b2, the transmitter sets the document 18. When the document 18 is set, the document detecting signal showing that the document 18 is set is given from the document detecting portion to the main unit control portion 11, and the main unit control portion 11 causes the display portion 9 to display the screen shown in FIG. 8A.

At this moment, ‘SEND READY’ is displayed on the display portion 9. This can inform the transmitter that the document 18 is set. Moreover, the present date, the present time, the use condition of the memory portion 7 and the like are displayed on the display portion 9. A display of the present date is, for example, ‘2003/06/27.’ A display of the present time is, for example, ‘08:30 AM.’ A display of the use condition of the memory portion 7 is, for example, ‘M: 00%.’

Next, at step b3, the transmitter presses down the report key 21. When the report key 21 is pressed down, it is inputted as the second condition from the inputting means 20 to output the transmission result information, and the main unit control portion 11 causes the display portion 9 to display the screen shown in FIG. 8B. At this moment, ‘REPORT RESERVATION’ and ‘ENTERED’ are displayed on the display portion 9. This can inform the transmitter that the report key 21 is pressed down.

After that, the main unit control portion 11 causes the display portion 9 to display the standby screen shown in FIG. 8C. At this moment, ‘SEND READY (REPORT RESERVED)’ of the result display confirming information is displayed on the display portion 9. This can inform the transmitter that the report key 21 has already been pressed down. Moreover, the present date, the present time and the use condition of the memory portion 7 are displayed on the display portion 9 in the same manner as in the screen shown in FIG. 8A.

The standby screen shown in FIG. 8C is displayed in the standby state for waiting for the various operations from the transmitter, between a point that the report key 21 is pressed down and a point that the start key 32 is pressed down at step b5 described later. Thus, in the standby state between the point that the report key 21 is pressed down and the point that the start key 32 is pressed down, the result display confirming information such as the standby screen shown in FIG. 8C is displayed. As a result, in between the respective operations, it is possible to make the transmitter recognize that the report key 21 has already been pressed down.

Next, at step b4, the transmitter executes, on the key inputting portion 8, a predetermined operation for polled reservation. When the predetermined operation is executed on the key inputting portion 8, the main unit control portion 11 causes the display portion 9 to display the screen shown in FIG. 8D. At this moment, ‘MEMORY POLLED DATA SETTING’ is displayed on the display portion 9. This can inform the transmitter that polled reservation is made.

When polled reservation is made in this manner, the image information generated by the reading portion 5 at step b5 described later is transmitted when the communication apparatus 1 receives a transmission request from a destination.

Next, at step b5, the transmitter presses down the start key 32. When the start key 32 is pressed down, the main unit control portion 11 causes the reading portion 5 to start reading of the document 18. Moreover, when the start key 32 is pressed down, the main unit control portion 11 causes the display portion 9 to display the screen shown in FIG. 8E. At this moment, for example, ‘READING P. 001’ is displayed on the display portion 9. This can inform the transmitter that the document is being read.

When reading of the document 18 is finished, the main unit control portion 11 causes the data processing portion 10 to encode the image information generated by the reading portion 5, and stores into the memory portion 7. At this moment, the main unit control portion 11 associates the condition inputted at step b3 with the image information, and stores into the memory portion 7.

In this manner, when outputting the transmission result information is inputted from the inputting means 20, that is, when the report key 21 is pressed down, the main unit control portion 11 causes the display portion 9 to display the result display confirming information showing that the transmission result information is outputted. Thereafter, when a predetermined setting operation for transmission is finished, the main unit control portion 11 deletes the display of the result display confirming information on the display portion 9. The predetermined setting operation is a setting operation from setting the document 18 to pressing down the start key 32, and includes the operation for polled reservation and the operation for the various kinds of settings such as the image quality setting and the density setting.

Next, when the transmission request from the destination is received, at step b6, the image information stored in the memory 7 is transmitted by the transmitting and receiving portion 2 to the destination having made the transmission request via the communication line 17. The main unit control portion 11 causes to display the screen shown in FIG. 8F. At this moment, for example, ‘SENDING P. 001’ is displayed on the display portion 9. This can inform the transmitter that the image information is being transmitted.

When transmission of the image information stored in the memory portion 7 is finished, subsequently at step b7, the transmission result information is generated in the same manner as in the former example of the operation process, and the transmission result information is outputted. Moreover, the main unit control portion 11 causes the display portion 9 to display the screen shown in FIG. 8G. At this moment, ‘TRANSACTION REPORT STARTED’ is displayed on the display portion 9. This informs the transmitter that output of the transmission result information is started. After that, at step b8, the transmitter ends the operation of the communication apparatus 1.

Although the operation processes relating to output of the transmission result information are described referring to FIGS. 4, 5A to 5I, 6A and 6B, 7 and 8A to 8G described before, the operation processes described using these drawings can also be applied to storage of the transmission result information. That is, in FIG. 4, at step a3, when the report key 21 is pressed down, storing the transmission result information is inputted as the second condition from the inputting means 20, and the main unit control portion 11 causes the display portion 9 to display the screen shown in FIG. 5B. At step a7, when the transmission result information is generated, the main unit control portion 11 causes the memory portion 7 to store the generated transmission result information.

Furthermore, in FIG. 7, at step b3, when the report key 21 is pressed down, storing the transmission result information is inputted as the second condition from the inputting means 20, and the main unit control portion 11 causes the display portion 9 to display the screen shown in FIG. 8B. At step b7, when the transmission result information is generated, the main unit control portion 11 causes the memory portion 7 to store the generated transmission result information.

Further, although the description is given on the assumption that it is set as the preset first condition not to output the transmission result information referring to FIGS. 4, 5A to 5I, 6A and 6B, 7 and 8A to 8G described before, it may be set as the first preset condition of outputting the transmission result information. In this case, the transmission result information is not outputted when, for example, the report key 21 is pressed down.

Furthermore, not only the transmission result information is outputted by printing by the printing portion 6, but also the transmission result information may be outputted by displaying by the display portion 9. In this case, outputting means is structured to include the printing portion 6 and the display portion 9.

As described above, according to the former embodiment, the communication apparatus 1 has the transmitting and receiving portion 2 for transmitting to a destination by facsimile communication or Internet communication via the communication line 17, and the first condition with respect to whether or not to store or whether or not to output the transmission result information showing a transmission result of transmission information transmitted from the transmitting and receiving portion 2 is set before the predetermined transmission information is transmitted. The main unit control portion 11 gives a priority to the second condition than to the preset first condition when storing the transmission result information is inputted as the second condition from the inputting means 20, and causes the memory portion 7 to store the transmission result information. Moreover, the main unit control portion 11 gives a priority to the second condition than to the preset condition when outputting the transmission result information is inputted as the second condition from the inputting means 20, and causes the display portion 9 or the printing portion 6 to output the transmission result information by displaying or printing.

Since, after transmission information is transmitted, whether or not to store or whether or not to output the transmission result information on the transmission information is set by giving a priority over a setting state before transmission in this manner, what is required is merely to set by the inputting means 20 only when the setting is different from an initial setting before transmission, and therefore, the need for setting whether or not to store or whether or not to output the transmission result information for all transmission information is eliminated, with the result that it is possible to selectively output only the transmission result information on desired transmission in a simple operation.

Further, according to the former embodiment, when storing or outputting the transmission result information is inputted from the inputting means 20, the main unit control portion 11 causes the display portion 9 to display the result display confirming information showing that the transmission result information is stored or outputted, and thereafter, when a predetermined setting operation for transmission is finished, the main unit control portion 11 deletes the display of the result display confirming information on the display portion 9. Since the result display confirming information is displayed on the display portion 9 in this manner, it is possible to make the transmitter recognize that, when current transmission is finished, the transmission result information thereof is stored or outputted. Moreover, since the result display confirming information displayed by the display portion 9 is deleted when the predetermined setting operation for transmission is finished, it is possible by deleting the display of the result display confirming information to make the transmitter recognize that, on subsequent transmission, whether or not to store or whether or not to output the transmission result information thereof is not set.

Another embodiment of the invention is similar to the aforementioned embodiment, and a third condition with respect to whether or not to transmit the transmission result information from the transmitting and receiving portion 2 is inputted from the inputting means 20. In this embodiment, when transmitting the transmission result information is inputted as the third condition inputted from the inputting means 20, the main unit control portion 11 causes the transmitting and receiving portion 2 to transmit the transmission result information. The transmission result information is transmitted by, for example, electronic mail.

According to the latter embodiment, it is possible to select and input the third condition with respect to whether or not to transmit the transmission result information from the transmitting and receiving portion 2, by means of the inputting means 20. When transmitting the transmission result information is inputted as the third condition from the inputting means 20, the main unit control portion 11 causes the transmitting and receiving portion 2 to transmit the transmission result information, and it is possible to inform by transmitting the transmission result information to a destination of transmission information and a destination different from the destination of the transmission information. Consequently, it becomes possible to confirm the transmission result information by not only a personal communication apparatus but also another communication apparatus locating in a separate place, and the convenience of the confirmation of the transmission result information is increased.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A communication apparatus comprising a transmitting portion for transmitting predetermined transmission information to a destination via a communication line, the communication apparatus being capable of, before transmitting the predetermined transmission information, setting a first condition with respect to whether or not to store or output transmission result information showing a transmission result of transmission information transmitted from the transmitting portion, the communication apparatus further comprising:
inputting means for inputting a second condition with respect to whether or not to store or output the transmission result information for each transmission;
storing means for storing the transmission result information;
outputting means for outputting the transmission result information; and
controlling means for giving a priority to the second condition than to the preset first condition when storing the transmission result information is inputted as the second condition, and causing the storing means to store the transmission result information, and for giving a priority to the second condition than to the preset first condition when outputting the transmission result information is inputted as the second condition, and causing the outputting means to output the transmission result information.

2. The communication apparatus of claim 1, wherein:
a third condition with respect to whether or not to transmit the transmission result information from the transmitting portion is inputted from the inputting means; and
the controlling means causes the transmitting portion to transmit the transmission result information when transmitting the transmission result information is inputted as the third condition inputted from the inputting means.

3. The communication apparataus of claim 1, wherein:
the outputting means includes displaying means which is caused to display predetermined information by the controlling means; and
when storing or outputting the transmission result information is inputted from the inputting means, the controlling means causes the displaying means to display result display confirming information showing that the transmission result information is stored or outputted, and thereafter, when a predetermined setting operation for transmission is finished, the controlling means deletes the display of the result display confirming information on the display means.

4. The communication apparatus of claim 2, wherein:
the outputting means includes displaying means which is caused to display predetermined information by the controlling means; and
when storing or outputting the transmission result information is inputted from the inputting means, the controlling means causes the displaying means to display result display confirming information showing that the transmission result information is stored or outputted, and thereafter, when a predetermined setting operation for transmission is finished, the controlling means deletes the display of the result display confirming information on the display means.

5. A communication apparatus comprising a transmitting portion for transmitting predetermined transmission information to a destination via a communication line, wherein a first condition with respect to whether or not to store or output transmission result information showing a transmission result of transmission information transmitted from the transmitting portion is set as initial setting, the communication apparatus further comprising:
inputting means for inputting a second condition with respect to whether or not to store or output the transmission result information ‘for each transmission;
storing means;
outputting means; and
controlling means for controlling, when the second condition is inputted from the inputting means, the storing means with respect to storage of the transmission result information or the outputting means with respect to output of the transmission result information according to the second condition instead of the first condition.

6. The communication apparatus of claim 5, wherein:
a third condition with respect to whether or not to transmit the transmission result information from the transmitting portion is inputted from the inputting means; and
the controlling means causes the transmitting portion to transmit the transmission result information when transmitting the transmission result information is inputted as the third condition inputted from the inputting means.

7. The communication apparatus of claim 5, wherein:
the outputting means includes displaying means which is caused to display predetermined information by the controlling means; and
when storing or outputting the transmission result information is inputted from the inputting means, the controlling means causes the displaying means to display result display confirming information showing that the transmission result information is stored or outputted, and thereafter, when a predetermined setting operation for transmission is finished, the controlling means deletes the display of the result display confirming information on the display means.

8. The communication apparatus of claim 6, wherein:
the outputting means includes displaying means which is caused to display predetermined information by the controlling means; and
when storing or outputting the transmission result information is inputted from the inputting means, the controlling means causes the displaying means to display result display confirming information showing that the transmission result information is stored or outputted, and thereafter, when a predetermined setting operation for transmission is finished, the controlling means deletes the display of the result display confirming information on the display means.

9. A communication apparatus comprising a transmitting portion for transmitting predetermined transmission information to a destination via a communication line, wherein a first condition with respect to whether or not to store or output transmission result information showing a transmission result of transmission information transmitted from the transmitting portion is set as initial setting, the communication apparatus further comprising:
a controlling device;
an inputting device connected to the contolling device, for inputting a second condition with respect to whether or not to store or output the transmission result information for each transmission;
a storing device connected to the controlling device; and
an outputting device connected to the controlling device,
wherein the controlling device controls, when the second condition is inputted from the inputting device, the storing device with respect to storage of the transmission result information or the outputting device with respect to output of the transmission result information according to the second condition instead of the first condition.

10. The communication apparatus of claim 9, wherein:
a third condition with respect to whether or not to transmit the transmission result information from the transmitting portion is inputted from the inputting device; and
the controlling device causes the transmitting portion to transmit the transmission result information when transmitting the transmission result information is inputted as the third condition inputted from the inputting device.

11. The communication apparatus of claim 9, wherein:
the outputting device includes a displaying device which is connected to the controlling device and caused to display predetermined information by the controlling device; and
when storing or outputting the transmission result information is inputted from the inputting device, the controlling device causes the displaying device to display result display confirming information showing that the transmission result information is stored or outputted, and thereafter, when a predetermined setting operation for transmission is finished, the controlling device deletes the display of the result display confirming information on the display device.

12. The communication apparatus of claim 10, wherein:
the outputting device includes a displaying device which is connected to the controlling device and caused to display predetermined information by the controlling device; and
when storing or outputting the transmission result information is inputted from the inputting device, the controlling device causes the displaying device to display result display confirming information showing that the transmission result information is stored or outputted, and thereafter, when a predetermined setting operation for transmission is finished, the controlling device deletes the display of the result display confirming information on the display device.
